(19) United States
(12) Patent Application Publication
(10) Pub. No.: US 2013/0158965 A1
(43) Pub. Date: Jun. 20, 2013

(54) Physics Engine Systems Using "Force Shadowing" For Forces At A Distance

(71) Applicant: Christopher V. Beckman, New York, NY (US)

(72) Inventor: Christopher V. Beckman, New York, NY (US)

(21) Appl. No.: 13/326,235

(22) Filed: Dec. 14, 2011

(51) Int. Cl. G06G 7/48; G06T 17/20

(52) U.S. Cl. 703/6; 345/423

(57) ABSTRACT

New physics engine systems and related media and products implementing a “Force Shadowing” effect from ambient, uniformly distributed background energy, to describe or simulate forces at a distance are provided.

### COPYRIGHT AND TRADEMARK NOTICE

© Copyright 2010 Christopher V. Beckman. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Unless otherwise stated, all trademarks disclosed in this patent document, including, but not limited to, “Force Shadowing” and “Gravitational Shadowing,” and other distinctive names, emblems, and designs associated with product or service descriptions, are subject to trademark rights. Specific notices also accompany the drawings incorporated in this application; the material subject to this notice, however, is not limited to those drawings.

### FIELD OF THE INVENTION

The present invention relates to the field of systems and machine-readable media to predict and simulate the behavior of matter, for example, in creating navigation systems for vehicles, weather maps or computer-generated imaging (“CGI”) in the motion picture industry. In particular, the invention relates to a new, more universal treatment of forces at a distance and directly applied forces from collisions and other contact forces in physics engines.

### BACKGROUND

In the physical sciences, it has been long theorized that several universal forces (also known as “fundamental interactions”), such as gravity, electromagnetism, and the weak and strong nuclear forces, are applied or appear to be applied at a distance, with no physical contact between two objects transferring energy causing the phenomena. Such forces that appear to be applied at a distance, with no physical contact, are referred to as “forces at a distance.” The observed “forces at a distance” have been described with some accuracy by Newtonian and Relativistic equations, among others, which have been further integrated and employed in several useful applications.

Predictive, navigational, product design and cinematic simulations commonly implement 2-dimensional (“2D”) and 3-dimensional (“3D”) physical models, physics engines and other physics simulators for creating or simulating the appearance, properties and behavior of matter in various scenarios, and for rendering images and analyses reflecting those physical models and simulations.

For example, to create the motion picture Wall-E, the CGI development team at Pixar Animation Studios used several physical models and physics engines, including Open Dynamic Engine, to add physical models to Autodesk Inc.'s Maya software to simulate apparent physics for several scenarios, including a scene in which a space ship tilts and gravitational influence shifts, causing rigid bodies to shift and collide. See P. Kanyuk|Pixar Animation Studios, Brain Springs: Fast Physics for Large Crowds in Wall-E, Computing Now, Making Wall-E (IEEE, July/August 2009) (Video 7), available at http://www.computer.org/portal/web/computingnow/wall-e2. As another example, NASA engineers have also used Open Dynamics Engine to simulate the behavior of physical environments for robot design and general mission planning.

In practice, physics engines require a great deal of processing power to apply, with limited predictive value in complex simulations and systems. Such physics engines require integration, co-processing and net vectoring of a variety of differing physical forces in CPU-intensive output, such as image rendering. Complex differential equations, integrations and root finding are used to approximate the effects of the many differing physical forces brought to bear on physics models—which often combine forces, characteristics and equations of a wide variety, such as those for simulating fluid dynamics, wind resistance, gravity, electromagnetism (including colligative surface forces), dynamic destruction, elastic and inelastic collisions (with and without deformation), friction, rubbing, “stiction,” “meshing,” skeleton rigging, and other rigid body dynamics. Simulating the behavior of softer body objects, and using implicit and a priori simulative techniques (which attempt to create greater accuracy by accounting for the effects of more data, less restricted to particular time intervals) presents even greater complexities and requires even more CPU resources, making verisimilitude difficult to obtain in a cost-effective manner. Explicit models, a posteriori techniques, dual mesh systems (one of which is simplified for physics) and other artificial constraints are often used to simplify or control CPU demands or compensate for rogue additive factors and other artifacts of simulations (such as inaccurate, additive rounding and undesired oscillations), but often lead to less realism in rendered images or other output.

Specialized processors (such as PPUs and GPUs) have been developed with dedicated physics engine processing capabilities to reduce the load on CPUs, and improve performance in gaming contexts. However, PPU projects, like PhysX (from NVIDIA Corporation), are understood to accelerate performance predominantly in particle system physics generation.

The present application relates to new physics engine systems with a more uniform computational model focusing on collision detection and response, implemented in software, hardware or both, to render more realistic graphics and simulations in real time. This new physics engine provides a useful supplement or alternative to conventional physics engines, and can make better use of multi-threaded parallel processing, to name just a few of the surprising benefits.

### SUMMARY OF THE INVENTION

New physics engine systems; generating graphics, images, audio and other simulation output more efficiently, quickly and with greater realism, are provided. In some aspects of the invention, new techniques for applying, understanding and simulating forces at a distance are provided. Some aspects of the invention are termed “Force Shadowing” techniques because, as will be set forth in greater detail below, they comprise a mutual blocking or filtration effect between objects placed in a uniform, symmetrical background radiation. Among other surprising benefits, Force Shadowing techniques may be easier to apply using processors and other physics engine hardware components.

Within the context of this application, unless otherwise indicated, the following terms have the specific meaning described herein:

“Image” means a visual or other representation or communication involving, at least in part, a tangible medium, where it is recorded, and is the recording itself, and does not necessarily, but may, include associated non-representational or partially representational elements, such as metadata and internal and external relational aspects, (for example, seeded or borrowed elements, or such as a deformation integral and acceleration second derivative of position of a subject object, respectively). Images may be 2-, 3-dimensional or otherwise multidimensional and may refer to composites of other images and non-visual media, such as other electromagnetic radiation, sound waves, olfactory, or tactile media. Thus, in addition to traditional visual images, an “image,” as meant in this application, may refer to recordings that may or may not be rendered or depicted visually, such as a sound or 3-dimensional tactile representation.

“Unreal matter” means any hypothetical, virtual (or computer-generated), augmented reality, imagined, simulated, pseudo-realistic or otherwise not fully real object(s), particles, electromagnetic waves or other physical matter or phenomena that may be impacted, or at least partially simulated to be impacted, by forces at a distance, and includes their approximation, identification or description, and may include the approximation, identification or description of some of the applied forces at a distance, in machine-readable media.

“Force Shadowing” means the real, simulation of, detection of or description of the occurrence of forces at a distance (whether actual, computer-generated/virtual, applied to Unreal Matter, or otherwise the result of design) including, but not limited to, gravity, the electric force, the magnetic force, electromagnetic forces, and the weak and strong nuclear forces, as being the result of a shadowing or blocking effect of more directly-applied, contact or collision-generated forces that are uniformly or symmetrically distributed in the space (virtual and/or real) in which the occurrences are present, simulated, detected or described. Force Shadowing includes, but is not limited to, describing forces at a distance as the result of shadowing, blocking and/or filtering by (including mutual shadowing, blocking and/or filtering between) objects (shadow “Casting Objects”) occupying 2D or 3D space of what would be (without the objects presence and interaction) a relatively uniform, symmetrical, constant or designed distribution in space (in terms of location and/or direction of movement or interaction) of energy, moving particles, waves or vectors (“Background Energy”) that interact with matter and/or waves distributed in the objects (for example, by collision). In this specifically included set of examples, it is preferred that a “relatively uniform” distribution is sufficient in concentration over any time frame to result in any two Casting Objects of matter described, considered or rendered by a physics engine using it, to experience a mutually attracting or repelling force as a result. It is even more preferred that, in the absence of such Casting Objects, the uniform distribution of Background Energy would be maintained from moment-to-moment, indefinitely, or that the source of the Background Energy particles, waves or vectors originates equally from all points in a uniform 2D or 3D grid of sufficient magnitude (or sufficiently growing in size) to create a negligible change in concentration over time in regions outside of the blocking or filtering effect of any objects treated by the system. Force Shadowing refers to each separately, any and all of the aspects of actual, simulation of, detection of or description of forces, as may be applicable in the context of the use of the term, in the present application.

### BRIEF DESCRIPTION OF THE DRAWINGS

FIG. 1 depicts a side view of a 3D scenario that might be modeled by a system according to aspects of the present invention, including two spheres in “empty” space, with no starting velocity relative to one another, but which the system will permit to influence one another with gravity.

FIG. 2 depicts a sampling of particle and/or wave trajectories or propagation paths, presumed by the system to be emanating from a uniform distribution of points in space.

FIG. 3 depicts the same scenario as FIG. 1, further illustrating an example uniform grid distribution of points in space, captured in the side view of the illustration, and with some Force Shadowing effects of radiation, such as the exemplary radiation pictured in FIG. 2 depicted with respect to one such point of origin on the far side of the bottom sphere.

FIG. 4 depicts the same scenario as FIGS. 1 and 3, but also showing a “mirror image” Force Shadowing effect from a point of origin which is in the same position relative to the top sphere as the point of origin discussed in FIG. 3 is situated relative to the bottom sphere.

FIG. 5 depicts the same scene as FIG. 4, adding several additional examples of originating points, and depicting the area of the effects of even more origination points.

FIG. 6 depicts the overall effect area of Force Shadowing, in the scene discussed above, with respect to FIGS. 1-5.

FIG. 7 is a block diagram of some elements of a system which may be used to simulate, predict and/or detect Force Shadowing in accordance with aspects of the present invention.

### DETAILED DESCRIPTION OF THE DRAWINGS

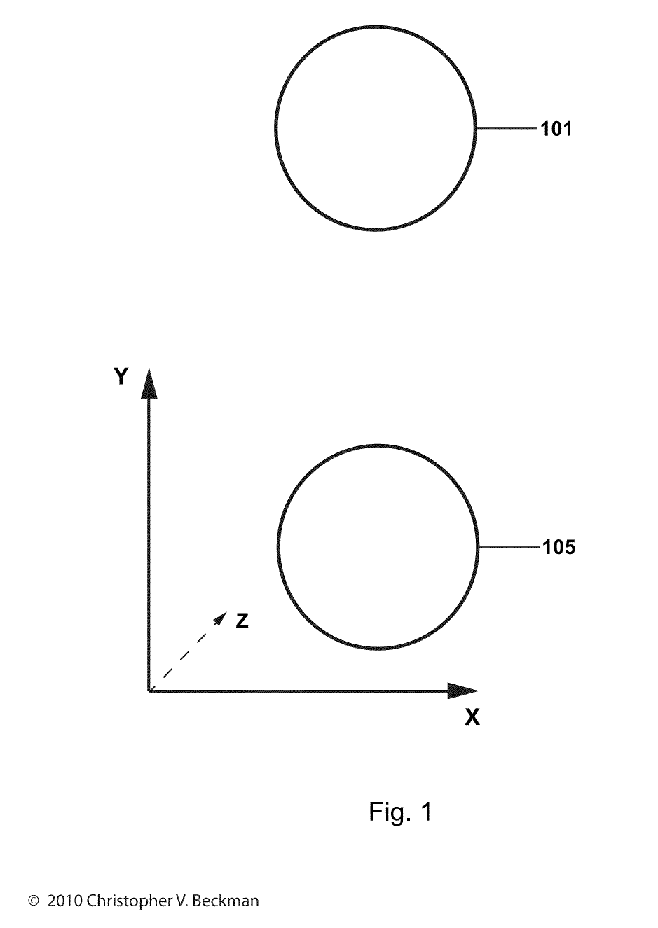

FIG. 1 depicts a side view of a 3D scenario, as might be modeled in a computer-generated environment and/or virtual space (using virtual objects, virtual energy and virtual vectors), by a system according to aspects of the present invention. Where this application refers to objects subject to or implementing Force-Shadowing, Casting Objects, Background Energy and other aspects of the invention, it should be understood that such phenomenon may be modeled in such virtual space by a system of a physics engine, rather than in real space only. However, it should also be understood that many of the aspects of the present invention may be carried out in real space as well.

In FIG. 1, two identical solid massive spheres, 101 and 105, begin the simulation (or modeled environment or prediction scenario or actual implementation) at rest with respect to one another. However, as will be depicted in further figures, discussed below, a system according to aspects of the present invention will consider and apply the influence of a simulated or real “force at a distance,” such as virtual gravity or a force at a distance created by radiation as Background Energy, that each spherical mass 101 and 105 has on the other. The system will create, consider or apply forces at a distance in a unique way, which is more consistent and fungible with other force calculations calculated by physics engines—by describing or emulating direct physical interaction, such as by collision detection and response.

More specifically, according to aspects of the present invention, a new model may be used for emulating or describing all forces, including forces at a distance, considering only direct physical interactions, such as the collisions of objects, vectors and energy, and resolving momentum, attributes and vectors after such interactions (hereinafter, the “Force Shadow” model). Under aspects of the present invention, only the consideration of such direct physical interactions is necessary to describe and resolve all forces affecting a scenario. In the Force Shadow model, it is taken as a given that forces, including gravity, electromagnetism and the weak and strong nuclear forces, are or may be described as the net or secondary effect of objects or waves with momentum or inertia occupying space, colliding, rubbing or passing through one another, or otherwise directly contacting and transferring energy in the process (“inter-colliding”). In such a Force Shadow model, gravity, electromagnetism and the weak and strong nuclear forces are themselves a shadowing or blocking effect from ambient, abundant or ubiquitous radiation, waves, vectors or moving particles (“Background Energy”). The inter-colliding radiation, waves, particles and/or waves may be assumed to travel substantially at the speed of light, which would also permit or explain the ubiquitous common concentration of such waves or particles in different reference frames (which reference frames may move or accelerate with respect to one another through areas and space).

Some basis for understanding the potential nature of some aspects of such a uniform common distribution of Background Energy is, in fact, found in the Universe in the form of the background microwave radiation thought to be an echo of the Big Bang, originating the Universe. Due to the uniform speed of electromagnetic waves in all frames of reference, and without regard for relative movement or acceleration of frames of reference with respect to one another, the background microwave radiation is not observed to increase in concentration based on speed alone of a frame of reference “moving” with respect to another frame of reference, and each frame of reference experiences the same essential uniform distribution. In addition to simulations, actual systems of Background Energy may be created to take advantage of aspects of the present invention in real space, as opposed to the computer-modeled space of a 3-D virtual scenario depicted by a physics engine system using the Force Shadow model. In any event, a physics engine of the present system is highly scalable to describe the behavior of observable galaxies, the overall expansion outward into the Universe of which is observed to be occurring and accelerating. Aside from the hypothesized curvature of space in higher dimensions of Relativity, a uniformly distributed wave or moving particles in an observed space, as in the Background Energy treated by systems and aspects of the present invention, would, overall, move outward into the Universe, colliding more, overall, with the inside surfaces toward a common center of the objects although, as will be explained in greater detail, below, it would also cause gravitational or other attractive forces between Casting Objects that, if close enough to one another, will accelerate toward one another locally (in regions depending on Background Energy levels and interactivity with Casting Objects, each of which may be variably set by a user). In addition, in real space, as yet unobserved abundant or ubiquitous radiation or moving particles might also potentially meet the expectation that a great deal of unobserved (or, not directly observed) matter and energy is present in the universe (a.k.a. “Dark Energy” and “Dark Matter”).

Whether or not a Force Shadow model, incorporating the influence of relatively abundant or ubiquitous radiation or moving particles, is ultimately a viable hypothesis for extant phenomenon in the Universe, its resolution of forces at a distance with a common approach to other forces that are determined, resolved and applied in physics engines makes a Force Shadow model highly valuable for that purpose. The Force Shadow model, or Force Shadowing, describes forces applied at a distance as actually the effect whereby two or more objects block ambient surrounding activity (Background Energy) from one another, with the net effect of greater force on the Casting Objects' (or constituent particles') outside surfaces than the Casting Objects' (or constituent particles') inside surfaces, which inside surfaces are protected from a greater concentration of Background Energy occurring outside of the pair of objects in space. Each object shields the other, causing an overall attraction effect. This phenomenon will be explained in greater detail with reference to the remaining figures.

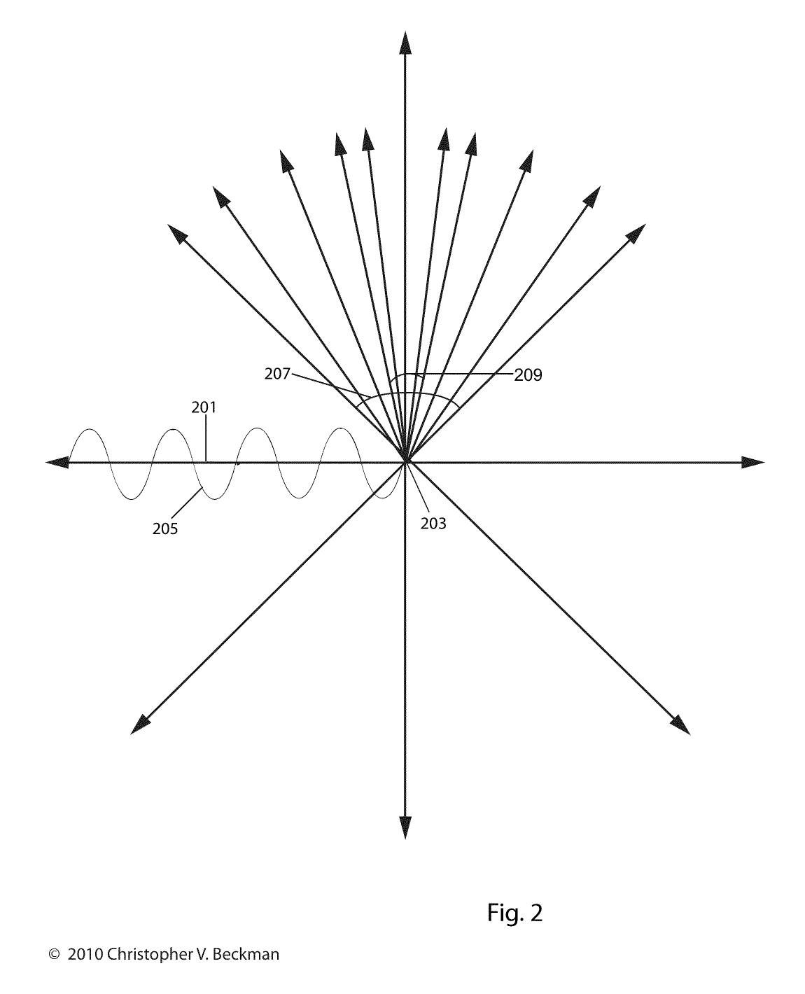

FIG. 2 is a graphical depiction of a sampling of “background” particle stream or wave velocities (a component of a form of Background Energy, as might be used by aspects of the present invention), according to aspects of the present invention. According to aspects of the present invention, such waves or particle streams, as represented by an arrow/ray showing their direction of propagation (e.g. 201, shown as emanating from a point in space, 203) may be described by the system to be emanating from each of a uniform or symmetrical distribution of points in space. (For example, a uniform distribution of points in space might be a 3-dimensional grid.) As shown in electromagnetic wave propagation 205, if background waves are described, a waveform (e.g., that described by Maxwell's equations describing the EM waveform) might propagate as shown along the vector/arrow/ray path 201. However, it is to be understood that each of the arrows shown in FIG. 2 may represent a particle stream, wave, or other Background Energy propagation path. A system in accordance with aspects of the present invention might further place such background waves and/or particle streams in enough uniformly distributed instances at distributed angles such that, at any timeframe (e.g., a generation frame based on a frame rate), such waves and particle streams remain evenly distributed (in terms of concentration and velocity direction) in space (or CGI virtual space). Preferably, the number of instances and the distribution of angles are dense enough to cause any two objects within the space or design or rendering virtual space or area to share the path of at least three wave or particle stream instances at any given frame or collision calculation point and in sufficient symmetrical concentrations, velocities and other respects that any two Casting Objects will be subjected to resulting force from the Background Energy. It is to be understood that the number and angular distribution of emanating waves and particles shown in FIG. 2 is purely illustrative, and that a greater, more uniform and space-filling density will be required in most applications. If a small number of objects are modeled within the system, it is possible for a greater density to be applied only in directions that will affect objects, and still meet the “uniformity” or “symmetry” requirement for Background Energy, while saving processing power. Purposeful asymmetries, to cause particular accelerations of Casting Objects and other objects influenced by Force Shadowing, is also possible according to aspects of the present invention. To render the significance of the figure more clearly, a greater density of waves or particles is shown emanating from the top of the point in FIG. 2, included in angle 207. In this figure, the four top-most wave or particle stream propagations (included in angle 209) emanate from the origination point 203 at 5- or 6-degree angle intervals. However, it is to be understood that a much different, or greater density, and different uniformity and uniform angles may be applied, and that this density and simple angle choice are strictly to demonstrate the basic function of aspects of the invention.

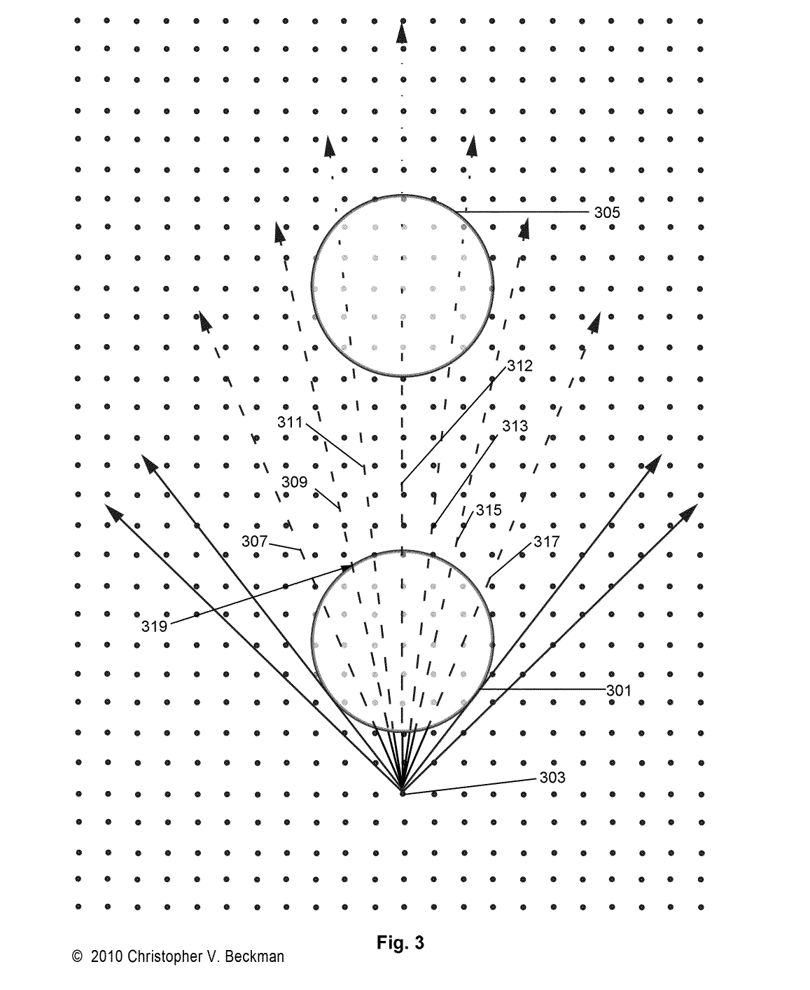

FIG. 3 depicts the same scenario as FIG. 1, further illustrating a simplified uniform, symmetrical grid distribution of points in space. It should be understood that a greater or lesser density of grid points, and a different uniform layout, may be used for the aspects discussed in this figure. Once again, the depiction captures the scene in the same side view as FIG. 1, but, for ease of illustration, with only one plane of the uniform grid (which may, in actuality, be 3-dimensional) apparent. Also, to illustrate the uniform distribution of particles or waves applied by the system (Background Energy), a much smaller demonstrative subset of such waves or particles, as also selected for discussion in FIG. 2, are transposed onto a point within the grid space, 303. In real space, a number of approaches may be taken to generate Background Energy, including targeted emitters training at any and all of the uniform points in the space grid, and which moderate the strength and density such that all points experience the same distribution of energy, from and to any number of uniform angles via origination points that do not interfere with the Casting Objects in their Force Shadowing role. A Background Energy existing in nature, extant or discovered, may also be used. Particle or wave propagation paths 307-317 each first pass through sphere 301, at symmetrically distributed points on the surface facing point 303. By passing into the matter of sphere 301, the wave or particle stream may refract to some degree, depending on material characteristics and surface shape, but for simplicity in illustration, the example of FIG. 3 does not include refraction, and the original angles of emanation are preserved. Also, it may be necessary to change the propagation angles and concentration from that shown to ensure continued uniform density at later points in time, such as frames for collision detection, resolution and rendering. In the scenario of FIG. 3, part of the particle stream or the wave may be viewed as colliding with matter within the sphere, while a residual amount remains at the points of exit, e.g., 319. As would be expected, the amount of collisions per particle or wave propagation density unit continues in a relatively uniform manner throughout the sphere, made of a relatively consistent material, and a steady percentage attrition of the wave strength or number of particles remaining as the Background Energy passes through the sphere can be seen on the way through, as demonstrated by increasingly dashed lines until exit at a final intensity or density, e.g., line 309 after departing the sphere at exit point 319. Once in open space again, the attrition of the ray describing the particle stream, energetic wave or other Background Energy stops, as shown by a steady density dashed line following exit. In the physics engine context, the collisions or other absorption or blocking within the sphere causing the decreased intensity or density can be simulated and controlled, among other ways, by tessellation of “mesh” skeletons describing the boundaries of Casting Objects, for example, with semi-porous space-filling polygons in conjunction with angle jitter in the particle stream or wave (or using a cylindrical or twisting cylindrical propagation path). In any event, with or without jitter or cylindrical paths, groups of Background Energy with the same origination point (or perpendicular area centered on the origination point, in the instance of cylindrical paths) are termed a “group of background energy units with a common vector” in this application. Preferably, the porousness of the tessellation objects filling a Casting Object may be varied by the user, and may be varied, along with Background Energy concentrations, vectors and other characteristics (which may be varied dynamically) to simulate different densities at different locations within a Casting Object, and may simulate any nature of force at a distance. For example, if a greater effect at a greater distance is required, the intensity of the Background Energy or its impact upon collision with a Casting Object can be increased, and the size of the tessellation holes/pores can be decreased. The size of the tessellation pores may also be shaped to more or less match or block, or may otherwise set to react with, the oscillation pattern or shape of a select waveform or particle. Thus, many different types of Background Energy may be used in one system, tuning different Casting Objects to react with different Background Energy.

Groups of background energy with common vectors along propagation paths 311, 312 and 313 continue through space to collide with matter in sphere 305, and again collide with its surface facing the direction of emanation point 303, at positions symmetrical to that point of origin. However, owing to the percentage attrition (which may or may not be scalar, but is preferably scalar rather than more complex in function) in density and strength from collisions in sphere 301, their collisions with sphere 305 are far more sparse, and weaker on the inside surface of sphere 305 (meaning the surface facing, and shielded or “shadowed” by the other sphere, 301).

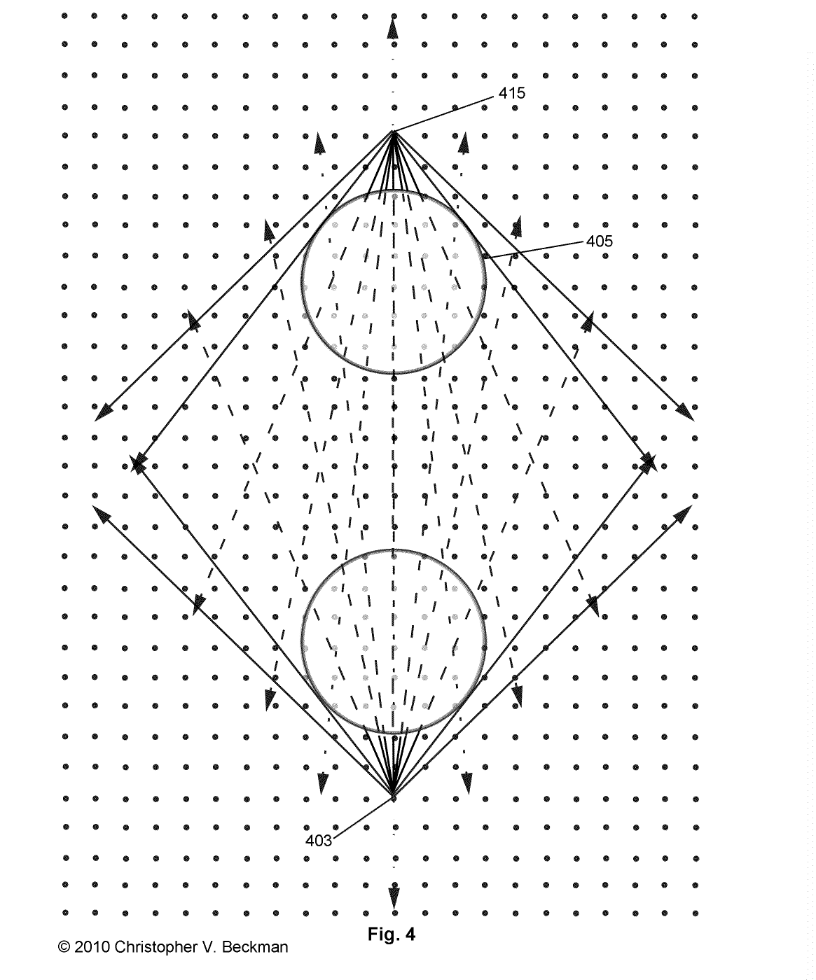

FIG. 4 depicts the same scenario as FIGS. 1 and 3, but also showing a mirror image effect from a point of origin 415, which is in the same position relative to the top sphere, now shown as 405, as the point of origin discussed in FIG. 3 for the bottom sphere. As one can see, the net effect of their mutual shielding (or Force Shadowing) is an overall greater collision or other interaction force on the outer surfaces of the spheres, than on the inner surfaces, because the same amount of Background Energy collides with the outside surfaces of particles comprising the sphere at full strength, whereas only the substantially eroded Background Energy interacts with the inside surfaces (sides of the sphere particles facing the other sphere). This net effect will lead the spheres to begin attraction toward one another, and the same is true (although to differing degrees) when all uniformly distributed grid points outside of the sphere system are factored in as points of origin, like points 403 and 415, because Background Energy emitted from them must pass no less through the outer surface of both spheres from points on either side, and somewhat less on the inside surfaces, owing to this shadowing effect. With the proper density and collision incidence, (assuming that all points emanate uniformly and at the uniform angles discussed above) and with changes in the shape of absorptive characteristics of the matter simulation, such as pore sizes, shapes and resistances within matter simulators, any force at a distance may be simulated, and a wide variety of forces may be created or detected, with this approach. Furthermore, the physical model of the force delivery for the objects may be adjusted dynamically by the user with such control points as the objects grow nearer or farther to approximate the change over a distance from center of any force at a distance.

To account for repulsive forces at a distance, such as those sometimes resulting from magnetic effects, Force Shadowing may still be used, for example, with reversal or other alterations to collision reaction vectors used in either a priori or a posteriori collision modeling. Alternatively, the system can add a pool of additional substantially uniform particles that collides or otherwise interacts with the blocking or filtering objects (Casting Objects) treated in the system, for example, by collision detection and reaction, and are also collided with or otherwise interacted with by the Background Energy, but in which the Background Energy does not directly interact with the Casting Objects. Thus, the Casting Objects can be made to “float” in the opposite direction of acceleration of the intermediate objects, as a balloon filled with helium will float in heavier (more greatly pulled) Earth atmosphere. This can be executed in interactive parameter settings for objects created or manipulated by the system, in a user interface with controls for classes of Casting Objects, Background Energy, and these now newly-discussed intermediate objects for repulsion forces—including different classifications for objects that will and will not collide or otherwise interact with other classes of objects, as set in any combination selected by a user.

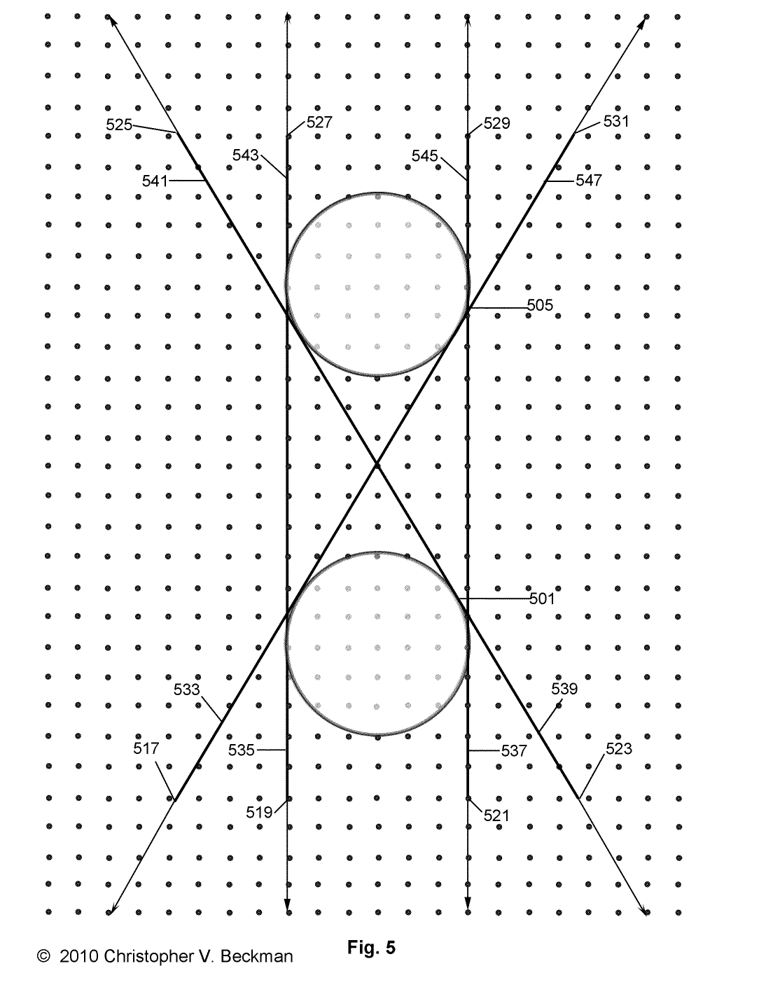

FIG. 5 depicts the same scene as FIG. 4, but now adding examples of originating points 517, 519, 521, 523, 525, 527, 529 and 531. Originating points 517, 519, 521 and 523 are in line with and to the left and right of the previously-considered origination point below the bottom sphere, which sphere is now shown as 501, whereas originating points 525, 527, 529 and 531 are to the left and right of the previously considered origination point above the top sphere, which sphere is now 505, in the same relative configuration as with 501 and its four new points. Once again, therefore, as in FIG. 4, FIG. 5 depicts opposing (in this case, mirror image) effects between two objects under the Force Shadow model. These new origination points are chosen for illustration because some of their propagation rays are substantially tangential to both spheres, which tangent propagation rays are shown as numbers 533, 535, 537, 539, 541, 543, 545 and 547. Once again, it is understood that in Force Shadowing, a plethora of uniform or symmetrical energetic particles, waves or other vectors are propagating from any and every point in the grid (Background Energy) and, preferably, toward at least every other point in the grid. Thus, the new origination points and outer tangential line boundaries actually define boundaries of the sweep of space which may yield Background Energy that is shadowed by one sphere for the other—not simply the propagation paths.

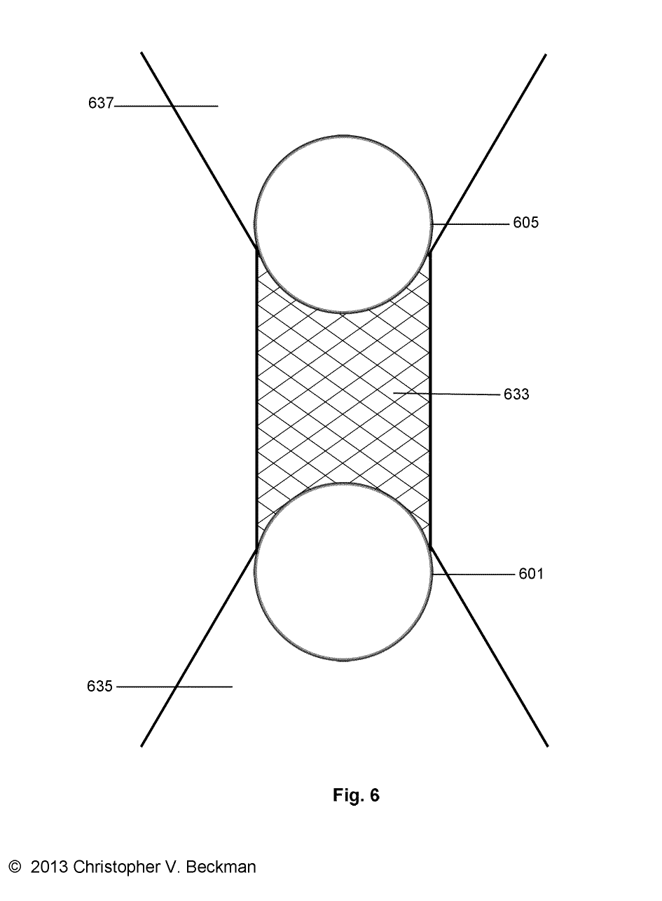

FIG. 6 reduces the areas where mutual Background Energy shadowing effects occur in a region 633, which may be shaded for greater clarity, but are within the sweep of the tangential boundaries discussed with respect to FIG. 5, and the regions of the spheres themselves, now depicted as 601 and 605. In other words, Region 633 (and the spheres) is the region where the Background Energy and energy density has been depleted due to mutual blocking by Casting Objects 601 and 605 and which results in a differential or imbalance of forces leading to acceleration of the Casting Objects (and/or particles within them). FIG. 6 also shows regions with originating points yielding the shadowed space as region 635 and 637. In this way, we may visualize the areas of the Force Shadowing, depicting the effect of a force at a distance, such as gravity, as originating from an intercolliding Background Energy. Much greater shadows of potential influence exist for both spheres as well, but need not be discussed in this simpler scenario with just two Casting Objects.

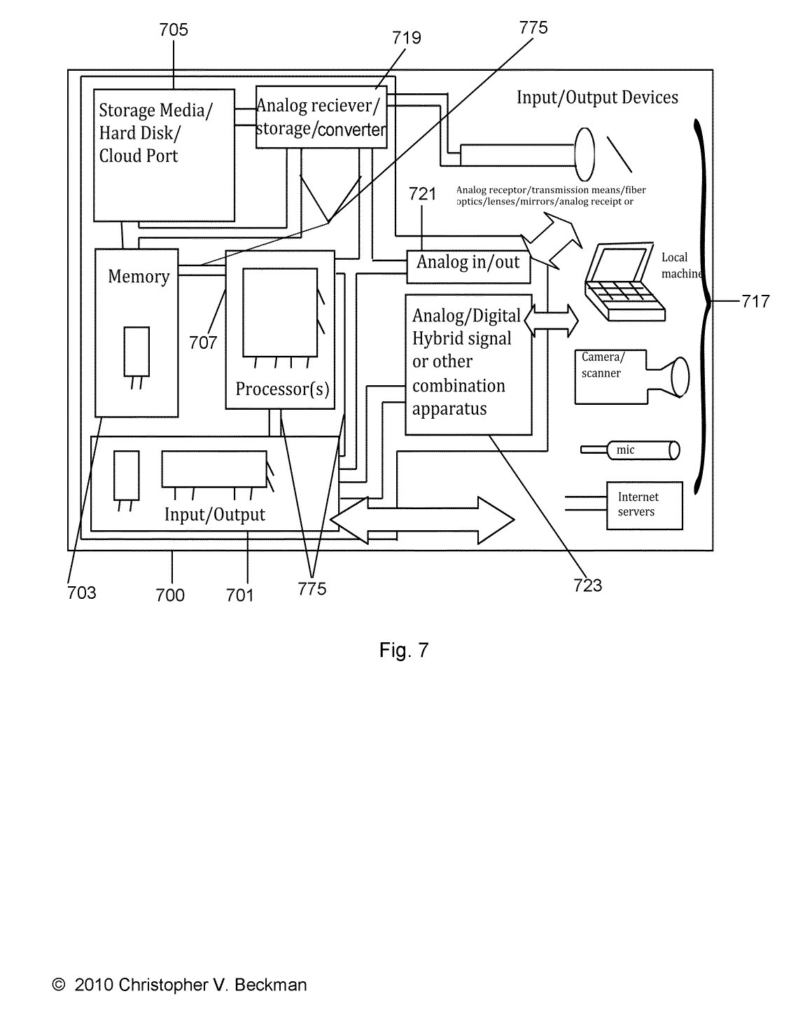

FIG. 7 is a schematic block diagram of some elements of a system 700 that can be used in accordance with aspects of the present invention. The generic and other components and aspects described are not exhaustive of the many different systems and variations, including a number of possible hardware aspects and machine-readable media that might be used, in accordance with the invention. Rather, the system 700 is described here to make clear how aspects may be implemented. Among other components, the system 700 includes an input/output device 701, a memory device 703, storage media and/or hard disk recorder and/or cloud storage port or connection device 705, and a processor or processors 707. The processor(s) 707 is (are) capable of receiving, interpreting, processing and manipulating signals and executing instructions for further processing and for output, pre-output or storage in and outside of the system. The processor(s) 707 may be general or multipurpose, single- or multi-threaded, and may have a single core or several processor cores, including microprocessors. Among other things, the processor is capable of processing signals and instructions for the input/output device 701, analog receiver/storage/converter device 719, and/or analog in/out device 721, to cause a user interface to be provided for use by a user on hardware, such as a personal computer monitor or terminal monitor with a mouse and keyboard and presentation and input software (as in a GUI). For example, window presentation user interface aspects may present a user with the option to select and command the detection or creation of Casting Objects, or to vary their characteristics or locations and direct their accelerations or to vary concentrations and amounts and number of types of Background Energy, as discussed above, for example, with drop-down menus, selection, movement and resizing control commands (e.g., mouse with cursor or keyboard arrows) with different settings for each such characteristic, or drawing and color palette tools, and other user interface aspects known in the art of physics engines, physical modeling, detecting, image-creation and remote control (and each of their related software field) arts. The processor 707 is capable of processing instructions stored in memory devices 705 and/or 703 (or ROM or RAM), and may communicate via system buses 775. Input/output device 701 is capable of input/output operations for the system, and may include innumerable input and/or output hardware, such as a computer mouse, keyboard, networked or connected second computer, camera or scanner, mixing board, real-to-real tape recorder, external hard disk recorder, additional movie and/or sound editing system or gear, speakers, external filter, amp, preamp, equalizer, computer display screen or touch screen. It is understood that the output of the system may be in any perception form, because the acceleration of Casting Objects may effect virtually generated or actual sound, touch, taste or any other sensed phenomenon. Such a display device or unit and other input/output devices could implement a user interface created by machine-readable means, such as software, permitting the user to carry out the user settings and input discussed in this application. 701, 703, 705, 707, 719, 721 and 723 are connected and able to communicate communications, transmissions and instructions via system busses 775. Storage media and/or hard disk recorder and/or cloud storage port or connection device 705 is capable of providing mass storage for the system, and may be a computer-readable medium, may be a connected mass storage device (e.g., flash drive or other drive connected to a U.S.B. port or Wi-Fi) may use back-end (with or without middle-ware) or cloud storage over a network (e.g., the internet) as either a memory backup for an internal mass storage device or as a primary memory storage means, or may simply be an internal mass storage device, such as a computer hard drive or optical drive. Generally speaking, the system may be implemented as a client/server arrangement, where features of the invention are performed on a remote server, networked to the client and made a client and server by software on both the client computer and server computer.

Input and output devices may deliver their input and receive output by any known means, including, but not limited to, the examples shown as 717. Because the images managed, manipulated and distributed may be any representational or direct impression captured from any activity of Casting Bodies or objects affected thereby, any phenomenon that may be sensed may be managed, manipulated and distributed may be taken or converted as input through any sensor or carrier known in the art. In addition, directly carried elements (for example a light stream taken by fiber optics from a view of a scene) may be directly managed, manipulated and distributed in whole or in part to enhance output, and whole ambient light information may be taken by a series of sensors dedicated to angles of detection, or an omnidirectional sensor or series of sensors which record direction as well as the presence of photons recorded, and may exclude the need for lenses (or ignore or re-purpose sensors “out of focal plane” for detecting bokeh information or enhancing resolution as focal lengths and apertures are selected), only later to be analyzed and rendered into focal planes or fields of a user's choice through the system. For example, a series of metallic sensor plates that resonate with photons propagating in particular directions would also be capable of being recorded with directional information, in addition to other, more ordinary light data recorded by sensors. While this example is illustrative, it is understood that any form of electromagnetism, compression wave or other sensory phenomenon may include such sensory directional and 3D locational information, which may also be made possible by multiple locations of sensing, preferably, in a similar, if not identical, time frame. The system may condition, select all or part of, alter and/or generate composites from all or part of such direct or analog image transmissions, and may combine them with other forms of image data, such as digital image files, if such direct or data encoded sources are used. Specialized sensors for detecting the depletion of Background Radiation of any type, and imaging the sources or capturing the forces applied based on the known characteristics of the Background Radiation and/or the Casting Objects, may also be included for input/output devices.

While the illustrated system example 700 may be helpful to understand the implementation of aspects of the invention, it is understood that any form of computer system may be used—for example, a simpler computer system containing just a processor for executing instructions from a memory or transmission source. The aspects or features set forth may be implemented with, and in any combination of, digital electronic circuitry, hardware, software, firmware, or in analog or direct (such as light-based or analog electronic or magnetic or direct transmission, without translation and the attendant degradation, of the image medium) circuitry or associational storage and transmission, as occurs in an organic brain of a living animal, any of which may be aided with external detail or aspect enhancing media from external hardware and software, optionally, by networked connection, such as by LAN, WAN or the many connections forming the internet. The system can be embodied in a tangibly-stored computer program, as by a machine-readable medium and propagated signal, for execution by a programmable processor. The method steps of the embodiments of the present invention may be performed by such a programmable processor, executing a program of instructions, operating on input and output, and generating output. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

As mentioned previously in this application, the CPU or other processor savings in treating different forces with a common collision or other physical interaction basis should not be underestimated. A processor may be highly specialized to deal with one form of interaction, rather than blend and resolve different vector sources and types of physical equations. In addition, using a Force Shadowing model where a user may control and manipulate the concentration and type or classification of Background Energy (in addition to changing the Casting Objects, other objects, or introducing them with different momentums and locations treated by the system (e.g., firing an arrow into the field of view in a video game) allows the user to simulate exothermic, endothermic and other kinetic effects (for example, causing explosions in video game play) within the same commonly resolved, generalized intercollision of Background Energy, Force Shadow approach.

To create the Background Energy presence/field, or such energetic effects, particle generation physics engine methods may be used, for example, using origination points within a grid, as discussed above. Alternatively, the system need not engage in particle generation if it instead begins with the description of such waves or particles already moving past such points in uniform angular concentrations.

The Force Shadowing model may be applied by a system according to aspects of the present invention to describe or simulate interactions of any size or type, including those leading to other collisions, such as the chemical bonds yielding the structural rigidity of a brick and the colligative nature of water, when a brick is tossed into a pond—all depending on the complexity of the scene treated or created by the user and/or system and processing power available in a CPU, GPU, PPU, or other processing unit of the system. It is understood that all collision and interactions in the Force Shadow model may be reduced to Force Shadow intercollisions of smaller particles. Even aesthetic parameters may be described and integrated in one system by the Force Shadowing model aspects of the present invention, as the interaction of objects colliding, reflecting and refracting light from origination points selected by the user for lighting (in other words, creating shadows and highlights).

It should be noted that, for simplicity of illustration, the above figures omit Background Energy origination points between two Casting Objects, which may in fact be included in the system according to aspects of the present invention, and the influence of which may, at the election of a user, contribute to the decrease in attractive force (in the instance of using Force Shadowing to simulate attractive forces, such as gravity) resulting from increased direct impact with the shadowed surfaces as the two Casting Objects move apart—for example, changing with the inverse of the square of the distance between the two Casting Objects (as in gravity). However, the concentration of background energy may be manipulated, and manipulated dynamically in response to any distance between two Casting Objects, to yield any mathematical relationship describing the changing force at a distance with distance of the Casting Objects. It should also be noted that, in 3D, the shapes of the Casting Objects, Shadows and originating points would be in 3 dimensions (e.g., creating cylindrical shadows, rather than rectangles, in the instance of the spheres discussed in earlier figures) and the mutual shadows will change size with the size of one or both of the Casting Objects accordingly. As would be expected, in 3 dimensions, decreasing either Casting Object mass by ½ also decreases the amount of collision shielding, and the resulting differential and applied force by ½. To simulate momentum, the Background Energy concentration may vary, or not be uniform, surrounding an accelerating Casting Object—with increased collisions on the leading surfaces of the accelerating Casting Object. Alternatively, momentum can be described as fundamental aspect, translating amounts of force applied to acceleration per unit of mass in an object, with a corresponding change in timeframe for the two frames of reference (one Casting Body under acceleration with respect to another) to explain the constant speed and concentration of the Background Energy in both frames of reference (despite acceleration and movement).

Finally, while applications in CGI and physics engines should be encouraged, Force Shadowing in actual 3-dimensional space has many other useful applications, for example, in telescopes, photography and communications, and surgery. For example, the controlled movement of a Casting Object (or objects), will lead to modulatable waves in Background Energy in real space, that can be sensed by other Casting Objects attached to sensors, and encoded, stored or decoded with otherwise known transmission and receiving and electrical engineering methods. The use of one fixed Casting Body, in conjunction with a movable Casting Body, and directed Background Energy, permits the selective movement of the movable Casting Body. The use of multiple fixed casting bodies, with variable/tunable reactions to Background Energy, or that are spaced such that directed Background Energy can be applied to more than one point on the movable Casting Body, permits an even more selective movement of the movable Casting Body, including rotation and any 3D shift desired. Together, these approaches permit many forms of remote control, such as using small Casting Bodies for direction in non-invasive surgery, for example, a nanoparticle with an abrasive surface which may be directed into an arterial plaque.

I claim:

1. A physics engine comprising a system that may use a Force Shadowing model to generate predictions, simulations, images, image streams, interactive game play or other tangible output and results.

2. The physics engine system of claim 1, in which decision trees, commands, instructions, programs or action protocols use or incorporate output from the use of Force Shadowing.

3. The physics engine system of claim 1, in which the Background Energy may be variably controlled by the system and/or a user.

4. The physics engine system of claim 1, in which the Background Energy may be variably controlled by the system and/or the user to cover or affect only those modeled regions in which Casting Objects would, if the Background Energy were present to cover or affect those regions, shadow one another, or, in which Casting Objects may, if the Background Energy were present to cover or affect those regions, shadow one another.

5. The physics engine system of claim 1, in which the Background Energy is of a sufficient amount and concentration such that any two potentially Casting Objects will have an attracting or repulsing effect toward one another.

6. The physics engine system of claim 1, in which the Background Energy is sufficient such that, after passing through any and all Casting Objects, any group, or remaining part of a group that has not been blocked or shadowed, of background energy units with a common vector will still be present to some degree, although such group(s) may experience attrition in number of particles and/or strength by partial absorption or other interactions with matter within said Casting Objects.

7. The physics engine system of claim 1, in which the Background Energy is treated as not refracting or reflecting off of Casting Objects.

8. The physics engine system of claim 1, in which the Background Energy concentration and vector angles and Casting Object properties, including any dynamic properties, are set to simulate or predict the effect of gravity, electric forces, magnetic forces or the weak or strong nuclear forces.

9. The physics engine system of claim 1, in which different forms of Background Energy, that may interact with different Classes of Casting Objects, may be variably generated, detected or otherwise implemented by the user.

10. The physics engine system of claim 1, in which Casting Objects are framed and then tessellated with polyhedrons or other space-filling shapes that interact with Background Energy, but do not fully absorb Background Energy with vector direction(s) that pass through it.

11. The physics engine system of claim 10, in which said polyhedrons or other space-filling shapes comprise porous or at least partially hollowed polyhedrons or other space-filling shapes.

12. The physics engine system of claim 11, in which a user may variably set the number, size, density, shapes, porousness or hollowness of said polyhedrons or other space-filling shapes.

13. The physics engine system of claim 12, in which a user may variably set the reactivity, number, size, density, shapes or porousness or hollowness of said polyhedrons or other space-filling shapes by region, even within a single Casting Object.

14. The physics engine system of claim 1, in which a user or the system may set the degree or nature of interaction between Casting Objects and Background Energy.

15. The physics engine system of claim 1, in which a user or the system may set the degree or nature of said Casting Objects and Background energy dynamically.

16. The physics engine of claim 3, in which the user may direct the introduction of additional Background Energy at a particular point, location or region in the virtual space, for example, with an explosion simulation control within a GUI.

17. The physics engine of claim 16, in which said introduction of additional Background Energy at a particular point, location or region in the virtual space may destroy or modify the structure of virtual objects, such as the Casting Objects.

18. A method for simulating, detecting or directing the behavior of real or unreal matter with real or at least some unreal properties described or encoded in a machine-readable medium, comprising the following steps:
applying Force Shadowing to said real or unreal matter with real or at least some unreal properties described or encoded in a machine-readable medium.

19. The method of claim 18, in which the mass or forces applied to real or unreal matter is determined or exerted by the detection of the attrition, or pattern of attrition, of background energy or the direction of Background Energy in higher concentrations in regions of space.

20. A simulation or creative output material incorporating Force Shadowing or the results of Force Shadowing.

21. A communication device comprising a device that uses the movement of Casting Objects in a 3-dimensional field of Background Energy to generate modulated waves for the transmission of information over a distance.
